(19) United States
(12) Patent Application Publication
(10) Pub. No.: US 2010/0194710 A1
(43) Pub. Date: Aug. 5, 2010

(54) INFORMATION INPUT DEVICE AND INFORMATION INPUT/OUTPUT DEVICE

(75) Inventors: Takeo Koito, Aichi (JP); Shuji Hayashi, Aichi (JP); Tsutomu Tanaka, Kanagawa (JP); Hiroshi Mizuhashi, Kanagawa (JP); Yuko Yamauchi, Tokyo (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/696,235

(22) Filed: Jan. 29, 2010

(30) Foreign Application Priority Data
Feb. 5, 2009 (JP) 2009-025345

(51) Int. Cl. G06F 3/044

(52) U.S. Cl. 345/174

(57) ABSTRACT

An information input device includes: a first substrate; a second substrate formed opposite to the first substrate; and a position detection portion including at least three or more sensor electrodes and detecting a position at which at least one of the first substrate and the second substrate bends by electrical change among the sensor electrodes.

### BACKGROUND OF THE INVENTION

1. Field of the Invention

The present invention relates to an information input device and an information input/output device.

2. Description of the Related Art

A liquid crystal display device has advantages such that it is thin in thickness and light in weight as well as power consumption of which is low. Therefore, the liquid crystal display device is widely used for electronic apparatuses for mobile applications such as a cellular phone and a digital camera. The liquid crystal display device has a liquid crystal panel in which a liquid crystal layer is sealed between a pair of substrates, in which light irradiated from a planer light source such as a backlight provided on the back surface of the liquid crystal panel is modulated by the liquid crystal panel. Then, images are displayed on the front surface of the liquid crystal panel by the modulated light.

In recent years, a liquid crystal display device having a touch panel is used, in which icons displayed on a screen of the liquid crystal display device are directly touched by a user to input the instruction contents of the user.

The touch panel is provided at the uppermost side of the liquid crystal display device so that the instruction contents shown in the screen of the liquid crystal display device can be selected by being touched directly using a human's hand or an object. A position touched by the hand or the object is detected in the touch panel and an input signal indicating the contents instructed by the touched position drives the liquid crystal display device. When the liquid crystal display device including the touch panel is used for a computer and the like, an input device such as a keyboard or a mouse is not necessary, and when the liquid crystal display device is used for mobile products such as a cellular phone, an input device such as a keypad is not necessary. Therefore, the liquid crystal display having such touch panel tends to be widely used.

On the other hand, since the touch panel is arranged at an upper part of the liquid crystal display device, optical characteristics are deteriorated in the products including the touch panel due to effects the thickness, increase of the size or a refractive interface. There is also a problem of cost increase because the touch panel is necessary in addition to the liquid crystal display device, therefore, integral forming of the liquid crystal display and the touch panel is considered.

In recent years, a liquid crystal display device including a so-called sensor function is proposed, in which the liquid crystal display device and the touch panel are integrally formed as described above. As one of the liquid crystal display devices having the sensor function, a method of detecting external pressure generated when the hand or the object touches the liquid crystal panel of the liquid crystal display device by electrical contact between a pair of substrates constituting the liquid crystal panel is disclosed in JP-A-2007-95044 (Patent Document 1).

An outline configuration of a liquid crystal display device of related art having a sensor function, that is, a liquid crystal display device including the touch panel is shown in FIG. 22A and FIG. 22B. A liquid crystal display device 100 of related art having the sensor function includes an array substrate 101, a counter substrate 102 provided opposite to the array substrate 101 and a liquid crystal layer 103 interposed between the array substrate 101 and the counter substrate 102.

First, the array substrate 101 will be explained.

The array substrate 101 includes an insulating substrate 104 and plural thin-film transistor (hereinafter, referred to as TFTs) 107 which are switching elements formed on the insulating substrate 104 so as to correspond to pixels. Above the TFTs 107, a planarization film 105 for coating and planarizing the TFTs 107, and pixel electrodes 106 connected to the TFTs 107 through contact portions 118 formed in the planarization film 105 are pattern-formed on the planarization film 105. Moreover, above the pixel electrodes 106, a not-shown alignment film is disposed.

Next, the counter substrate 102 will be explained.

The counter substrate 102 includes a transparent insulating substrate 109 made of glass or polycarbonate resin (PC) and the like, a color filter layer 110 formed on one principal surface of the insulating substrate 109 and a planarization film 111 formed on the color filter layer 110. On planarization film 111, a protruding sensor adjustment layer 115 and a common electrode 112 formed on the whole surface including the sensor adjustment layer 115 are disposed. Furthermore, spacer layers 114 formed for maintaining the thickness of the liquid crystal layer 103 are arranged at given positions on the common electrode 112 and a not-shown alignment film is formed on the whole surface except the spacer layers 114.

The color filter layer 110 is made of a resin film having dye or pigment including three primary colors of red (R), green (G) and blue (B).

The planarization film 111 planarizes the surface of the color filter layer 110, which is made of a light-transmissive material.

The sensor adjustment layer 115 is formed in a protruding manner at a given position on the planarization film 111, which is formed so as to have a value smaller than a cell thickness (thickness of the liquid crystal layer 103). The common electrode 112 is formed on the whole surface including the sensor adjustment layer 115. In related art, a sensor electrode 116 is formed by the common electrode 112 formed on the upper surface of the sensor adjustment layer.

The spacer layers 114 are formed on the common electrode 112 apart from one another at equal intervals, which are formed in a columnar shape at the height of a given cell thickness. The cell thickness between the array substrate 101 and the counter substrate 102 is maintained by the spacer layers 114.

The counter substrate 102 and the array substrate 101 having the above configurations are arranged while maintaining a given cell thickness so that respective alignment films 108, 113 face toward the inside. The cell thickness is maintained to be constant on the surface by the height of the spacer layers 114, and a given liquid crystal material is sealed into the cell thickness to thereby form the liquid crystal layer 103.

In the liquid crystal display 100 having the above configuration, the liquid crystal cell is constituted by the pixel electrodes 106 formed at each pixel 121, the common electrode 112 and the liquid crystal layer 103. The sensor electrode 116 and the pixel electrode 106 at a position facing the sensor electrode 116 constitute a position detection portion 126 detecting a touch position.

FIG. 22B shows a schematic plane configuration of the liquid crystal display device 100. In FIG. 22B, the pixel electrodes formed on the array substrate 101 and signal wirings and a scanning wiring connected to the pixel electrodes and TFTs on the array substrate 101 are shown. In the liquid crystal display device 100, an area surrounded by the signal wiring 120 and the scanning wiring 123 corresponds to one pixel 121. A position where the sensor electrode 116 is formed is shown by a dotted line in FIG. 22B.

FIG. 23 shows an equivalent circuit of the liquid crystal display 100 including the touch sensor shown in FIG. 22A and FIG. 22B. A signal inputted from a write circuit 127 is connected to a source electrode S of the TFT 107 through the signal wiring 120. A read circuit 128 is also connected to the signal wiring 120. A drain electrode D of the TFT 107 is connected to the pixel electrode 106 included in a liquid crystal cell LC and the position detection portion 126. A desired pulse signal is inputted to a gate electrode G of the TFT 107 from the scanning wiring 123. The common electrode 112 of the liquid crystal cell LC and sensor electrode 116 of the position detection portion 126 are connected to a common signal wiring Vcom.

When display is performed in the liquid crystal display device 100, a signal from the write circuit 127 turns on a switch SW1 to be inputted into the pixel electrodes 106 included in the liquid crystal cell LC through the TFT 107, and voltage is applied between the pixel electrodes 106 and the common electrode 112. Accordingly, alignment of the liquid crystal 117 in the liquid crystal cell LC is changed and desired display is performed.

In the liquid crystal display device 100 shown in FIG. 22A and FIG. 22B, pressure is applied by pushing the counter substrate 102 with a touch object 125 such as a hand or a finger. Then, the sensor electrode 116 touches the pixel electrode 106 on the array substrate 101 facing the sensor electrode 116 through the alignment films 108, 113. At that time, in the circuit shown in FIG. 23, the signal from the common signal wiring Vcom is inputted to the signal wiring 120 through the TFT 107 and turns on a switch SW2 to be read to the read circuit 128. Accordingly, the contact between the sensor electrode 116 and the pixel electrode 106 is detected, thereby detecting a position touched by the touch object 125.

In the liquid crystal display 100 of related art having the above sensor function, the sensor electrode 116 and the pixel electrode 106 are electrically connected to thereby detect the position touched by the touch object 125. Therefore, the detection of the touched position can be performed with application of smaller external pressure as the distance between two electrodes is closer. In addition, the smaller the difference of height between the spacer layer 114 and the sensor electrode 116 is, the better the touching performance as the sensor becomes. In the above liquid crystal display device 100, the touched position can be detected easily by the contact between a pair of the sensor electrode 116 and the pixel electrode 106. However, on another front, when the difference of height between the spacer layer 114 and the sensor electrode 116 is too small, the sensor electrode 116 and the pixel electrode 106 are constantly touched in the case that there exists a conductive foreign matter, which may increase the probability of detection error. Furthermore, when the sensor electrode 116 is formed on the pixel electrode 106 side to have a configuration in which the pixel electrode 106 doubles as the sensor electrode 116, a portion of the sensor electrode 116 will be a point detect, which affects image quality. That is to say, there may occur significant problems in yield or quality.

Particularly, in the liquid crystal display device 100, rubbing processing for aligning liquid crystal is performed on surfaces of the array substrate 101 and the counter substrate 102 which face the liquid crystal layer 103, and foreign matters caused by the rubbing processing and foreign matters such as coating material of the color filter tend to be generated. Therefore, the above problems tend to occur.

The above problem of the detection error in the sensor function due to foreign matters may occur not only in the case that the sensor function is included in the liquid crystal display device but also in a configuration in which the sensor function is included in other display devices or a configuration including only the touch panel.

### SUMMARY OF THE INVENTION

In view of the above, it is desirable to provide an information input device and an information input/output device which are highly sensitive with good yield.

According to an embodiment of the invention, there is provided an information input device including a first substrate, a second substrate and a position detection portion. The first substrate and the second substrate are formed opposite to each other. The position detection portion includes at least three or more sensor electrodes and detects a position at which at least one of the first substrate and the second substrate bends by electrical change between the sensor electrodes.

In the information input device according to the embodiment of the invention, the position at which the substrate bends can be detected by three or more sensor electrodes, therefore, a touched position in the substrate can be detected, and further, error detection can be reduced by using three or more sensor electrodes.

According to another embodiment of the invention, there is provided an information input/output device including a first substrate, a second substrate, a position detection portion, a pixel electrode and a common electrode. The first substrate and the second substrate are formed opposite to each other. The position detection portion includes at least three or more sensor electrodes, and detects a position at which at least one of the first substrate and the second substrate bends by electrical change among three sensor electrodes. The pixel electrode and the common electrode are formed in each pixel and the amount of light emitted from the first substrate or the second substrate is controlled by change of voltage or current between electrodes in the pixel electrode and the common electrode.

In the information input/output device according to the embodiment, the position at which the substrate bends can be detected by three or more sensor electrodes, therefore, a touched position in the substrate can be detected, and further, error detection can be reduced by using three or more sensor electrodes.

Further, a desired image can be displayed by controlling the amount of light emitted from the first substrate or the second substrate by change of voltage or current between electrodes in the pixel electrode and the common electrode.

According to the embodiments of the invention, it is possible to obtain an information input device and an information input/output device having high sensitivity as well as high yield.

### BRIEF DESCRIPTION OF THE DRAWINGS

FIG. 1A and FIG. 1B are a schematic cross-sectional configuration and a plane configuration of an information input/output device according to a first embodiment of the invention;

FIG. 2 is a schematic cross-sectional configuration view when the information input/output device according to the first embodiment is operated by a touch object;

FIG. 3 is an equivalent circuit of the information input/output device according to the first embodiment of the invention;

FIG. 4 is a graph of defective fraction in the information input/output device according to the first embodiment of the invention and an information input/output device of related art;

FIG. 5 is a schematic configuration view of a color filter layer which can be applied to the information input/output device according to the first embodiment of the invention;

FIG. 6 is a schematic configuration view of a color filter layer which can be applied to the information input/output device according to the first embodiment of the invention;

FIG. 7A and FIG. 7B are a schematic cross-sectional configuration and a plane configuration of an information input/output device according to a second embodiment of the invention;

FIG. 8 is a schematic cross-sectional configuration view when the information input/output device according to the second embodiment is operated by a touch object;

FIG. 9A and FIG. 9B are a plane configuration view and a cross-sectional configuration view taken along the line A-A′ in a modification example 1 of the second embodiment of the invention;

FIG. 10A and FIG. 10B are a plane configuration view and a cross-sectional configuration view taken along the line A-A′ in a modification example 2 of the second embodiment of the invention;

FIG. 11A and FIG. 11B are a schematic cross-sectional configuration view and a plane configuration view of an information input/output device according to a third embodiment of the invention;

FIG. 12 is a schematic cross-sectional configuration view when the information input/output device according to the third embodiment is operated by a touch object;

FIG. 13A and FIG. 13B are a schematic cross-sectional configuration view and a plane configuration view of an information input/output device according to a fourth embodiment of the invention;

FIG. 14 is a schematic cross-sectional view when the information input/output device according to the fourth embodiment is operated by a touch object;

FIG. 15 is a schematic cross-sectional configuration view of an information input/output device according to a fifth embodiment of the invention;

FIG. 16A and FIG. 16B are plane configurations in the information input/output device according to the fifth embodiment of the invention;

FIG. 17 is a schematic cross-sectional view when the information input/output device according to the fifth embodiment is operated by a touch object;

FIG. 18 is a schematic plane configuration view of an information input/output device according to a sixth embodiment of the invention;

FIG. 19A and FIG. 19B are schematic cross-sectional configuration views of an information input/output device according to the sixth embodiment of the invention;

FIG. 20 is a schematic cross-sectional view when the information input/output device according to the sixth embodiment is operated by a touch object;

FIG. 21 is a schematic cross-sectional configuration view of an information input device according to a seventh embodiment of the invention;

FIG. 22A and FIG. 22B are a schematic cross-sectional configuration and a plane configuration view of an information input/output device of related art; and

FIG. 23 is an equivalent circuit view of an information input/output device of related art.

### DESCRIPTION OF THE PREFERRED EMBODIMENTS

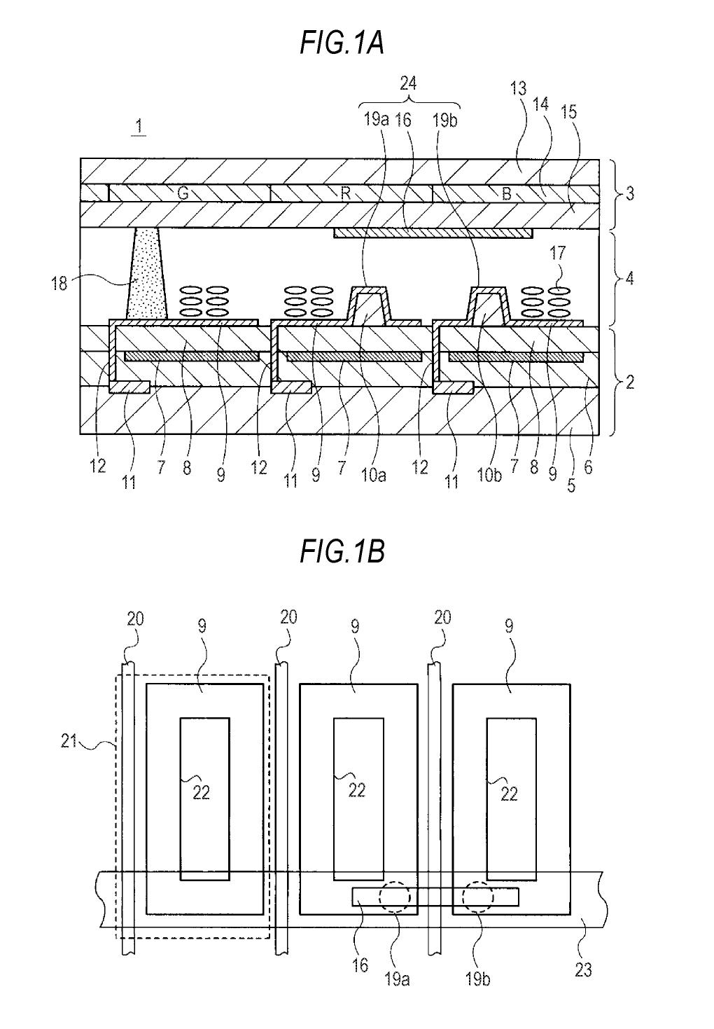

Hereinafter, examples of an information input device and an information input/output device according to embodiments of the invention will be explained with reference to FIG. 1A to FIG. 21. The embodiments of the invention will be explained in the following order. The invention is not limited to the following examples.

1. First Embodiment: an example of the information input/output device (a liquid crystal display device including a touch panel)
2. Second Embodiment: an example of the information input/output device (a liquid crystal display device including a touch panel)
3. Third Embodiment: an example of the information input/output device (a liquid crystal display device including a touch panel)
4. Fourth Embodiment: an example of the information input/output device (a liquid crystal display device including a touch panel)
5. Fifth Embodiment: an example of the information input/output device (a liquid crystal display device including a touch panel)
6. Sixth Embodiment: an example of the information input/output device (a liquid crystal display device including a touch panel)
7. Seventh Embodiment: an example of the information input device (a touch panel)

### 1. First Embodiment

### Configuration of an Information Input/Output Device

FIG. 1A and FIG. 1B show a schematic cross-sectional configuration and a planer configuration of an information input/output device according to a first embodiment of the invention. The information input/output device 1 shown in FIG. 1A and FIG. 1B is an example of a liquid crystal display device having a sensor function, that is, an example of a liquid crystal display device including a touch panel.

As shown in FIG. 1A, the information input/output device 1 according to the embodiment includes a first substrate 2 in which plural thin-film transistors (hereinafter, referred to as TFTs) 11 are formed, a second substrate 3 provided opposite to the first substrate 2 and a liquid crystal layer 4 provided between the two substrates. A position detection portion 24 formed between the first substrate 2 and the second substrate 3 is further included. The first substrate 2, the second substrate 3, the liquid crystal layer 4 and the position detection portion 24 will be described in detail in turn.

First, the first substrate 2 will be explained.

The first substrate 2 includes an insulating substrate 5, TFTs 11, an insulating film 6, common electrodes 7, an insulating film 8, a sensor adjustment layers 10a, 10b, pixel electrodes 9, first sensor electrodes 19a, 19b, spacer layers 18 and a not-shown alignment film.

The insulating substrate 5 is made of a transparent material such as glass or polycarbonate. Plural signal wirings 20 and plural scanning lines 23 formed so as to intersect the signal wirings 20 are formed above the insulating substrate 5 on the side facing the liquid crystal layer 4 as shown in FIG. 1B. At intersections of the signal wiring 20 and the scanning wiring 23, the TFTs 11 shown in FIG. 1A are formed though not shown in FIG. 1B. An area surrounded by the signal wiring 20 and the scanning wiring 23 forms one pixel 21.

The TFT is used as a switching element, and plural TFTs are provided in an array so as to correspond to pixels 21. The signal wiring 20 shown in FIG. 1B is connected to a gate electrode of the TFT 11 and the scanning wiring 23 is connected to a source electrode of the TFT 11 though not shown. Then, respective signals are supplied to the gate electrode and the source electrode of the TFT 11 from the signal wiring 20 and the scanning wiring 23.

The insulating film 6 is made of light-transmissive insulating material, which is formed on the whole surface coating the TFTs 11 on the insulating substrate 5. The common electrodes 7 are formed above the insulating film 6.

The common electrode 7 is a transparent electrode, which is formed by using a light-transmissive conductive material such as ITO. The common electrode 7 may be formed over the plural pixels 21, and a common potential is supplied to the common electrode 7 formed over the plural pixels 21.

The insulating film 8 is formed on the insulating film 6 by coating the common electrode 7, which is made of a light-transmissive insulating material.

The two sensor adjustment layers 10a, 10b are formed in a protruding manner on the insulating film 8 so that each of the pair of layers is provided on each of adjacent two pixels 21, which are formed to be lower than the thickness of the liquid crystal layer 4, namely, the cell thickness. The sensor adjustment layers 10a, 10b are preferably formed in a shielded area other than the light-transmissive area of the pixel 21. The sensor adjustment layers 10a, 10b are layers for adjusting the distance between first sensor electrodes 19a, 19b and a second sensor electrode 16 which are described later.

The pixel electrodes 9 are pattern-formed so as to correspond to respective pixels 21 on the insulating film 8 including the sensor adjustment layers 10a, 10b. In the light-transmissive area of the pixel electrode 9, plural slits (one slit in FIG. 1B) 22 are formed. The pixel electrode 9 formed in each pixel 21 is electrically connected to a drain electrode (not shown) of a corresponding TFT 11 through a contact portion 12 formed in the insulating film 8 and the insulating film 6. The pixel electrode 9 is a transparent electrode, which is formed by using a light-transmissive conductive material such as ITO.

In the embodiment, the pixel electrodes 9 formed over the sensor adjustment layers 10a, 10b double as the first sensor electrodes 19a, 19b included in the position detection portion 24. Also in the embodiment, two first sensor electrodes 19a, 19b formed so that each of the electrodes is provided on each of adjacent two pixels 21 makes a pair. Respective pixel electrodes 9 are connected to respective signal wirings 20 which are different according to the pixels 21 through drain electrodes corresponding to the TFTs 11. According to this, respective potentials are supplied to a pair of first sensor electrodes 19a, 19b from different signal wirings 20.

The spacer layers 18 are formed in a column shape at desired areas on the pixel electrodes 9 in order to maintain the thickness of the liquid crystal layer 4, namely, the cell thickness (cell gap) in the surface. The spacer layer 18 is preferably formed in a shielded area other than the light-transmissive area of the pixel.

In addition, a not-shown alignment layer is formed over the insulating film 8 facing the liquid crystal layer 4 including the pixel electrodes 9.

In the embodiment, the common electrode 7 and the pixel electrodes 9 facing the common electrode 7 constitute a display electrode.

Next, the second substrate 3 will be explained.

The second substrate 3 includes an insulating substrate 13, color filter layers 14, a planarization film 15, a second sensor electrode 16 and a not-shown alignment film.

The insulating substrate 13 is made of a transparent material such as glass or polycarbonate.

The color filter layers 14 are made of resin films including dye or pigment having three primary colors of red (R), blue (B) and green (G), which are formed on the side facing the liquid crystal layer on the insulating substrate in respective pixels 21.

The planarization film 15 is made of a light-transmissive insulating material, which is formed on the side facing the liquid crystal layer 4 on the color filter layers 14. The planarization film 15 is not inevitably necessary, but it is preferable that the planarization film 15 is formed in order to align the level of distance between the sensor electrodes which read electrical change.

The second sensor electrode 16 is formed on the planarization film 15 of the second substrate 3, which is formed at an area facing the first sensor electrodes 19a, 19b formed on the first substrate 2. The second sensor electrode 16 is a floating electrode, to which a potential is not supplied.

The second sensor electrode 16 is formed in a process different from the pixel electrode 9 and the common electrode 7 made of a transparent conductive material. Therefore, the second sensor electrode 16 is made of metal materials such as Mo, Al and Cr which are conductive materials, or conductive resin materials and the like, and formed in the same process as the process in which the black matrix is formed, thereby improving optical characteristics while reducing the number of processes.

Then, a not-shown alignment film is formed on the planarization film 15 facing the liquid crystal layer 4 including the second sensor electrode 16.

The alignment film is highly insulative in the same manner as the alignment film on the first substrate, therefore, sensitivity will deteriorate when disposed as it is. Accordingly, it is preferable that the alignment film on the second sensor electrode 16 is removed in another process or that the order of processes is changed and the second sensor electrode 16 is formed on the alignment film. Since the alignment film formed on the sensor adjustment layer is thinner than the alignment film on the electrodes other than the alignment film on the sensor adjustment layer, or the alignment film does not almost exist, therefore, the sensor sensitivity can be improved. Accordingly, it is desirable that the sensor adjustment layer is formed on the first substrate side or on both substrates.

Next, the liquid crystal layer 4 will be explained.

The liquid crystal layer 4 is formed by a liquid crystal 17 being sealed between the first substrate 2 and the second substrate 3 arranged in a state in which the alignment films thereof face each other. The thickness of the liquid crystal layer 4 is stably maintained by the height of the spacer layer 18 described above. In the embodiment, the liquid crystal layer 4, the pixel electrode 9 and the common electrode 7 constitute a liquid crystal cell in each pixel 21.

In the liquid crystal layer 4, the alignment of the liquid crystal 17 is changed by voltage applied to the pixel electrode 9 and the common electrode 7. The alignment of the liquid crystal 17 is changed and light transmitted through the liquid crystal layer 4 is modulated, thereby outputting desired information.

Three electrodes, namely, a pair of first sensor electrodes 19a, 19b and the second sensor electrode 16 existing between the first substrate 2 and the second substrate 3 having the liquid crystal layer 4 in between constitute the position detection portion 24. Accordingly, the information input/output device 1 according to the embodiment has a touch-sensor function.

The position detection portion 24 can adjust the distance between the first sensor electrodes 19a, 19b and the second sensor electrode 16 by adjusting the height of the sensor adjustment layers 10a, 10b. The distance between the first sensor electrodes 19a, 19b and the second sensor electrode 16 is preferably 0.5 μm or less for improving the sensitivity of the touch sensor. Also at this time, it is preferable that the heights of the sensor adjustment layers 10a, 10b are aligned, and the difference of heights between the first sensor electrodes 19a and the first sensor electrodes 19b is preferably 0.1 μm or less.

As described above, the height of the sensor adjustment layers 10a, 10b is adjusted to adjust the distance between the first sensor electrodes 19a, 19b and the second sensor electrode 16, thereby improving the sensitivity of the touch sensor. In the embodiment, the configuration in which the first sensor electrodes 19a, 19b are formed on the sensor adjustment layers 10a, 10b is applied, however, it is not limited to this. It is also preferable to apply a configuration in which the second sensor electrode 16 is formed on the sensor adjustment layer, or preferable to apply a configuration in which the first sensor electrodes 19a, 19b and the second sensor electrodes 16 are all formed on the sensor adjustment layer.

The position detection portion 24 is preferably formed on a shielding film which shields the scanning wiring 23 or at a shielded area in which the black matrix is formed for preventing deterioration of optical characteristics. Since it is necessary that the position detection portion 24 is formed at the shielded area, the open area ratio may be affected depending on resolution. Therefore, the position detection portion 24 is preferably formed at an area corresponding to the color filter layer 14 of red (R) or blue (B) when considering effects on light-transmittance of the position detection portion 24 in the information input/output device 1.

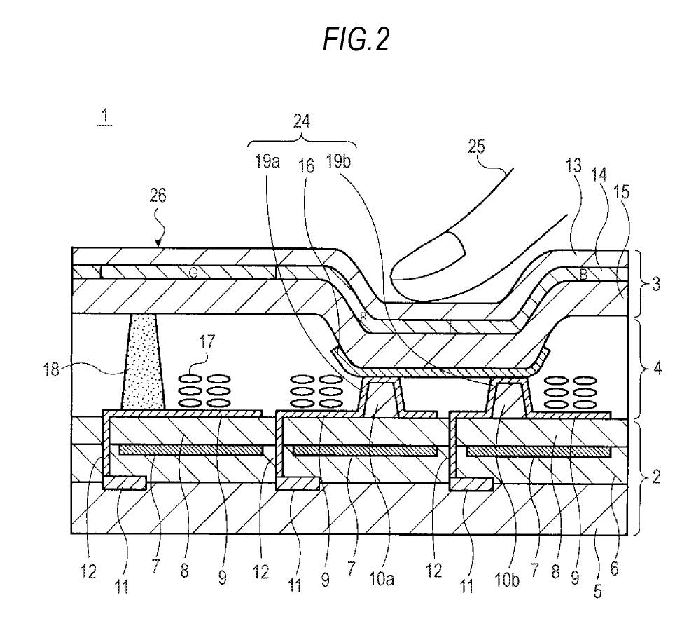

In the above information input/output device 1 according to the embodiment, the second substrate 3 bends towards the first substrate 2 by touching a display surface 26 with a touch object 25 such as a finger as shown in FIG. 2. Accordingly, the second sensor electrode 16 makes electrical contact with the two first sensor electrodes 19 in the position detection portion 24. According to this, the two first sensor electrodes 19a, 19b connected to different signal wirings 20 are electrically connected by the second sensor electrode 16 working as a bridge, which is a floating electrode, as a result, a touch position is detected.

Accordingly, in the information input/output device 1 according to the embodiment, desired information can be outputted by modulating light transmitted through the liquid crystal layer 4 as well as desired information can be inputted by detecting a touch position on the display surface by the position detection portion 24.

### [Drive Method of the Information Input/Output Device]

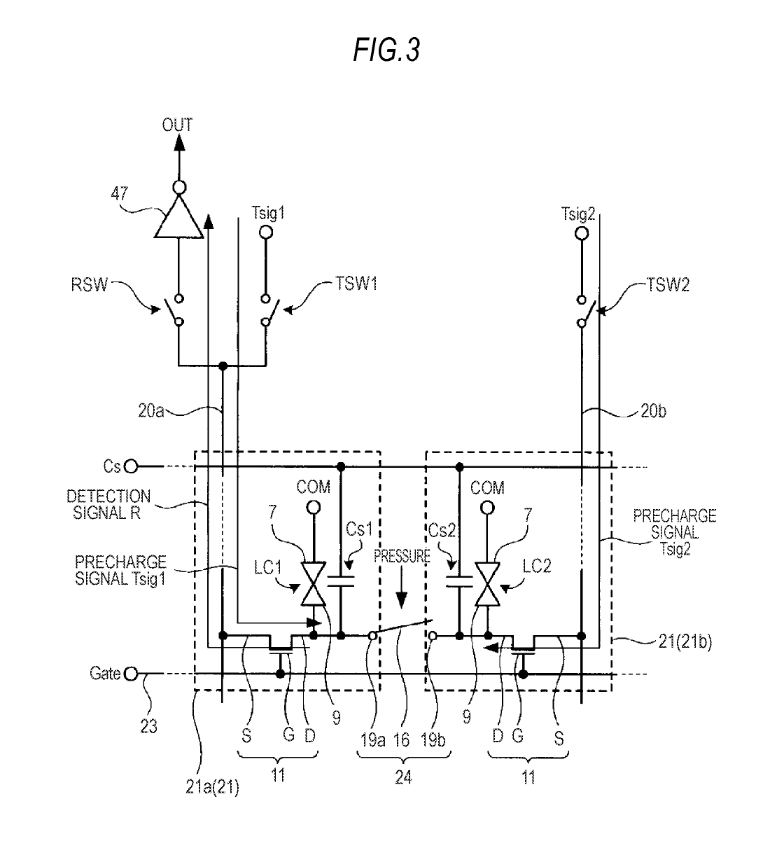

Hereinafter, an operation of detecting a touch position in the information input/output device according to the embodiment will be explained with reference to an equivalent circuit shown in FIG. 3.

FIG. 3 shows the equivalent circuit corresponding to two adjacent pixels 21. The first sensor electrode 19a is formed in one pixel 21a of the two pixels 21 and the first sensor electrode 19b is formed in the other pixel 21b.

A signal wiring 20a is connected to a source electrode S of the TFT 11 of one pixel 21a, and the scanning wiring 23 is connected to a gate electrode G. A drain electrode D of the TFT 11 is connected to a pixel electrode of a liquid crystal cell LC1, one of electrodes of a storage capacitor and the first sensor electrode 19a included in the position detection portion 24. A desired signal is inputted to the signal wiring 20a through a switch TSW1. To the signal wiring 20a, an output portion 47 of a detected signal R is connected through a switch RSW.

A signal wiring 20b is connected to a source electrode S of the TFT 11 of the other pixel 21b, and the scanning wiring 23 is connected to a gate electrode G. A drain electrode D of the TFT 11 is connected to a pixel electrode of a liquid crystal cell LC2, one of electrodes of a storage capacitor and the first sensor electrode 19b included in the position detection portion 24. A desired signal is inputted to the signal wiring 20b through a switch TSW2.

A common signal wiring Vcom is connected to the respective common electrodes 7 included in the pixels 21a, 21b, and a storage wiring Cs is connected to storage capacitors Cs1, Cs2. In the TFTs 11 of the pixels 21a, 21b, the source electrode S and the drain electrodes D are electrically connected by a pulse signal from the scanning wiring 23.

In the pixel 21a, a precharge signal Tsig1 is inputted to the source electrode S of the TFT 11 from the signal wiring 20a by turning on the switch TSW1. On the other hand, a precharge signal Tsig2 which has reverse polarity of the precharge signal Tsig1 is applied to the source electrode S of the TFT 11 from the signal wiring 20b by turning on the switch TSW2. The precharge signals Tsig1, Tsig2 are applied to the pixel electrodes 9, one of electrodes of storage capacitors Cs1, Cs2 and the first sensor electrodes 19a, 19b for a desired period by a pulse signal from the scanning wiring 23.

Here, in the position detection portion 24, the second sensor electrode 16 is connected to the first sensor electrodes 19a, 19b and the first sensor electrode 19a is electrically connected to the first sensor electrode 19b due to the pressing by the touch object. At this time, the switch TSW1 is in the off-state and the signal wiring 20a is in the floating state. Accordingly, the precharge signal Tsig2 having the reverse polarity is applied to the first sensor electrode 19b, therefore, the detection signal R having the potential of the precharge signal Tsig2 is inputted to one of signal wiring, in FIG. 3, the signal wiring 20a.

The detection signal R inputted to the signal wiring 20a from the position detection portion 24 through the TFT 11 is outputted through the output portion 47 by turning on the switch RSW.

As described above, the detection signal R from the position detection portion 24 is read by inputting the precharge signals polarity of which are reverse to each other into the signal wirings 20 (20a, 20b) of the two adjacent pixels (21a, 21b) in the information input/output device 1 according to the present embodiment.

In FIG. 3, the electrical change in the position detection portion 24 is detected as voltage change by the electrical connection between the first sensor electrodes 19a, 19b, however, the electrical change can be detected as capacitance change between the first sensor electrode 19a and the first sensor electrode 19b.

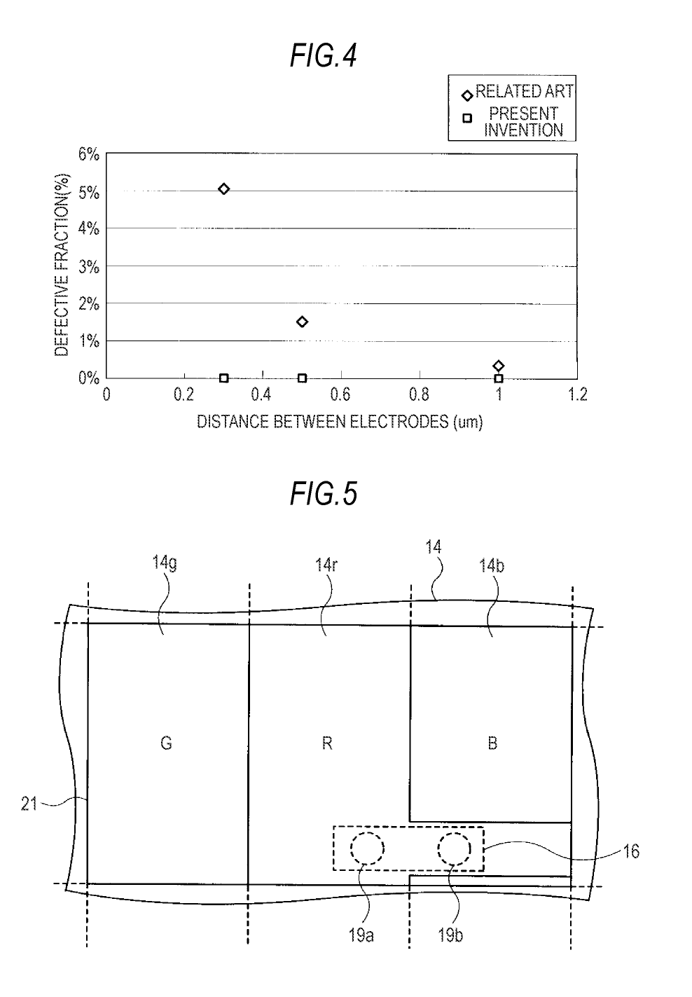

FIG. 4 shows the defective fraction of the information input/output device 1 according to the embodiment and the liquid crystal display device of related art including the touch sensor. Defects in this case indicate error detection or point detects caused by electrodes included in the position detection portion are constantly touched to each other due to foreign matters and the like. In FIG. 4, the horizontal axis represents the distance between electrodes (distance between the first sensor electrodes 19a, 19b and the second sensor electrode 16) and the horizontal axis represents the rate of incidents.

According to FIG. 4, in the liquid crystal display device of related art including the touch sensor, the defective fraction is drastically increased as the distance between electrodes included in the position detection portion is decreased. On the other hand, in the information input/output device 1 according to the embodiment, the defective fraction is almost 0% even when the distance between the first sensor electrodes 19a, 19b and the second sensor electrode 16 is decreased to 0.3 μm.

According to the above result, it is proved that the information input/output device 1 according to the embodiment is highly sensitive as well as has good yield.

In the information input/output device 1 according to the embodiment, the electrical change between the two first sensor electrodes 19a, 19b is performed by the second sensor electrode 16 working as a bridge, which is a floating electrode to which the potential is not applied. Namely, the touch position is detected only after the three sensor electrodes make contact with one another, therefore, error detection is decreased as compared with the case that the touch position is detected by the electrical change between two sensor electrodes. Accordingly, even when the distance between electrodes is reduced by using the sensor adjustment layers 10a, 10b to improve the sensor sensitivity of the position detection portion 24, error detection due to foreign matters is decreased and the yield can be improved.

The color filter layers 14 are usually formed so that colors are different between adjacent pixels as shown in FIG. 1A. Since the color filter layers 14 are formed by patterning in respective colors, film thicknesses of adjacent color filter layers 14 are different from each other, and the level difference occurs between pixels or the color filter layers 14 are formed in a concave state or a convex state, further, the color filter layers 14 are formed in an inclined state. In such cases, the difference occurs in the distance between the first sensor electrodes 19a, 19b and the second sensor electrode 16 at the position detection portion 24, which causes a problem that the control of sensitivity becomes difficult and a problem that the yield deteriorates.

Accordingly, it is preferable that the second sensor electrode 16 included in the position detection portion 24 is formed on the color filter layer 14 of the same color. FIG. 5 shows a plan view of the color filter layers 14, which is an example in which the color filter layer 14 is patterned so as to be extended between adjacent pixels 21 in an area where the second sensor electrode 16 is formed.

In the example of FIG. 5, a red color filter layer 14r is formed so as to be extended to the adjacent pixel, and the second sensor electrode 16 is formed on the red color filter layer 14r. Accordingly, the second electrode 16 is formed on the color filter layer 14r of the same color, which can suppress deterioration of touch sensitivity.

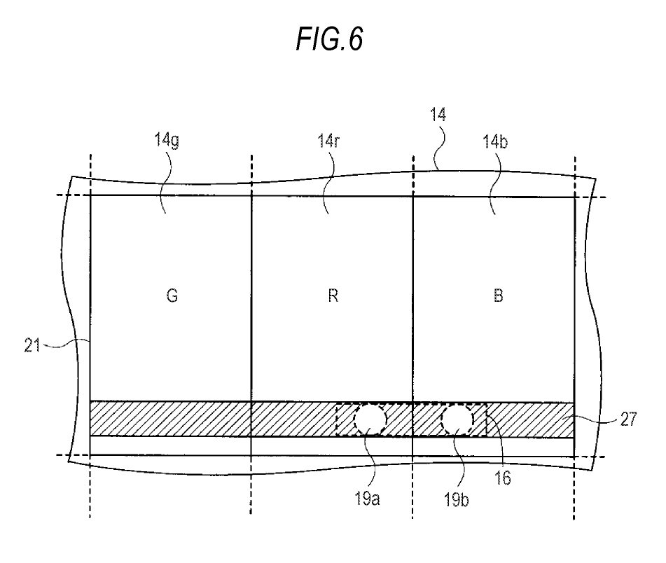

Additionally, as shown in FIG. 6, a black matrix 27 is formed at a position where the second sensor electrode 16 is formed in the same layer as the color filter layer 14, and the second sensor electrode 16 is formed on the black matrix 27. Also in this case, it is possible to form the distance between the first sensor electrodes 19a, 19b and the second sensor electrode 16 included in the position detection portion 24 in a stable manner.

### 2. Second Embodiment

### Configuration of the Information Input/Output Device

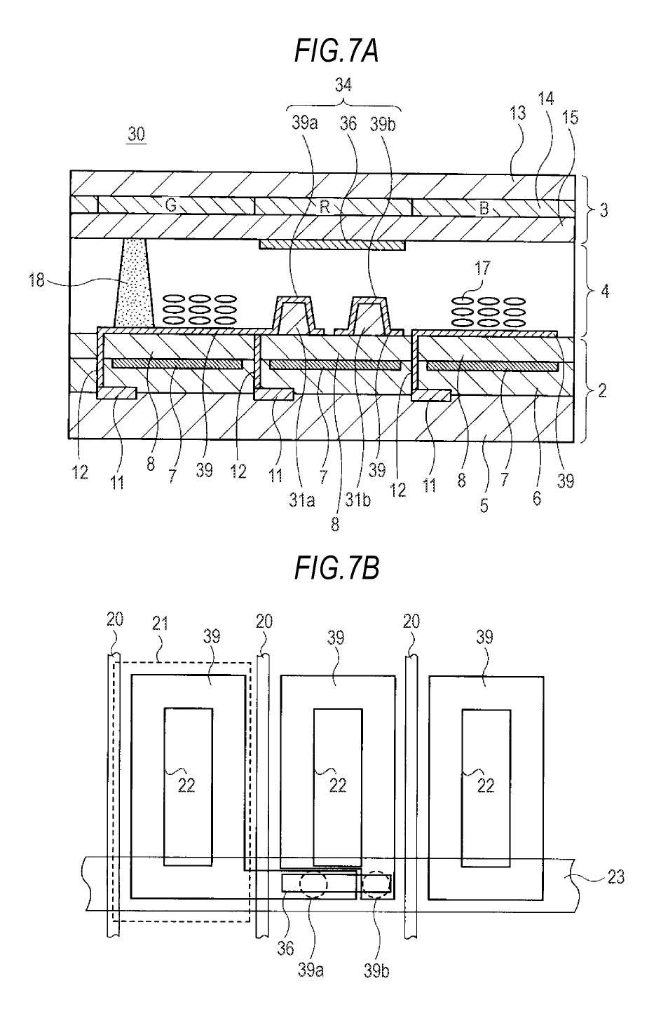

FIG. 7A and FIG. 7B show a schematic cross-sectional configuration and a plane configuration of an information input/output device according to a second embodiment of the invention. The information input/output device shown in FIG. 7A and FIG. 7B is an example of a liquid crystal display device having a sensor function, namely, an example of a liquid crystal display device including a touch panel. In FIG. 7A and FIG. 7B, the same symbols are given to portions corresponding to FIG. 1A and FIG. 1B and repeated explanation will be omitted.

The information input/output device according to the embodiment is an example in which the configurations of the pixel electrodes and the position detection portion in the information input/output device 1 according to the first embodiment are partly changed.

As shown in FIG. 7A and FIG. 7B, in an information input/output device 30 according to the embodiment, two sensor adjustment layers 31a, 31b are formed within one pixel 21 side by side in the direction in which the scanning wiring 23 extends. “Within one pixel” in this case indicates an area in which the color filter layer 14 for one pixel is formed. Then, a pixel electrode 39 included in the pixel 21 is formed on one sensor adjustment layer 31b of the two sensor adjustment layers, and a pixel electrode 39 included in a pixel 21 adjacent to the pixel 21 is formed on the other sensor adjustment layer 31a in an extended manner.

In the embodiment, the pixel electrodes 39 formed on the sensor adjustment layers 31a, 31b double as first sensor electrodes 39a, 39b included in the position detection portion 34. In the embodiment, two first sensor electrodes 39a, 39b formed in one pixel 21 makes a pair. To the pixel electrodes 39, potentials different by each pixel 21 are supplied through drain electrodes, and a pair of first sensor electrodes 39a, 39b are formed by adjacent pixel electrodes 39 respectively, therefore, different potentials are supplied to respective first sensor electrodes 39a, 39b. That is, each of a pair of first sensor electrodes 39a, 39b is connected to different signal wirings 20 through TFTs 11 respectively.

A second sensor electrode 36 is formed on the planarization film 15 of the second substrate 3 at an area facing the first sensor electrodes 39a, 39b formed on the first substrate 2. The second sensor electrode 36 is a floating electrode to which a potential is not supplied. Since the first sensor electrodes 39a, 39b are formed in the same pixel respectively in the embodiment, the second sensor electrode 36 can be formed at an area facing the color filter layer 14 of the same color. As described above, in the color filter layers 14 having different colors, the level difference occurs between respective color filter layers 14, therefore, unevenness in thickness is generated in a film formed extending on the color filter layers 14 having different colors. However, the two first sensor electrodes 39a, 39b are formed within one pixel 21 in the embodiment, therefore, the second sensor electrode 36 can be formed at an area facing the color filter layer of the same color, as a result, flatness of the second sensor electrode 36 can be obtained. Accordingly, reliability of the information input/output device 30 can be improved.

In the embodiment, three electrodes, namely, a pair of first sensor electrodes 39a, 39b and the second sensor electrode 36 constitute the position detection portion 34.

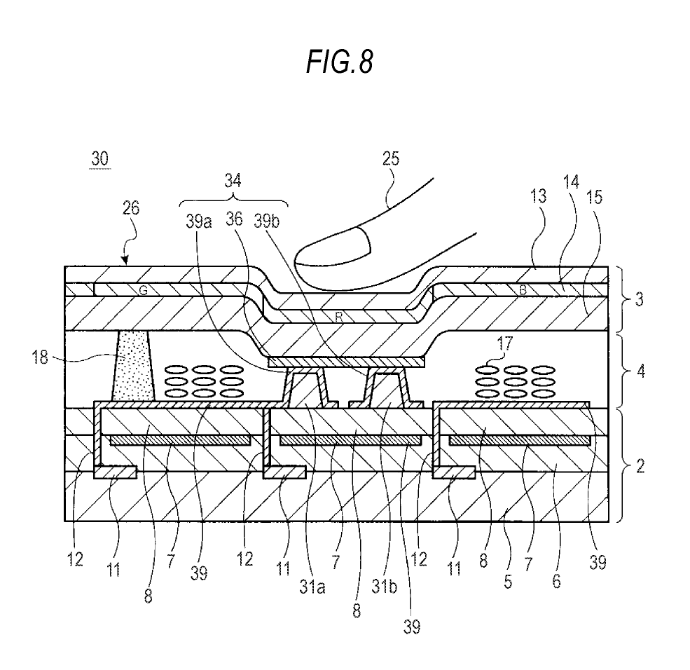

In the information input/output device 30 according to the embodiment, the second substrate 3 bends towards the first substrate 2 by touching the display surface 26 with the touch object 25 such as a finger as shown in FIG. 8. Accordingly, the second sensor electrode 36 makes electrical contact with the two first sensor electrodes 39a, 39b in the position detection portion 34. According to this, the two first sensor electrodes 39a, 39b connected to different signal wirings 20 are electrically connected by the second sensor electrode 36 which is a floating electrode working as a bridge, as a result, a touch position is detected.

At this time, also in the information input/output device 30 of the embodiment, the touch position is detected by the detection method using the same circuit configuration as the first embodiment.

Since two first sensor electrodes 39a, 39b are formed within one pixel in the embodiment, the second sensor electrode 36 is formed so as to face the same color filter layer 14, therefore, the level difference in the color filter layers 14 does not affect the second sensor electrode 36. Other advantages which are the same as the first embodiment can be also obtained.

In the embodiment, the two first sensor electrodes 39a, 39b are formed side by side in the direction of the scanning wiring 23, however, the following modification examples can be further applied.

### Modification Example 1 of the Second Embodiment

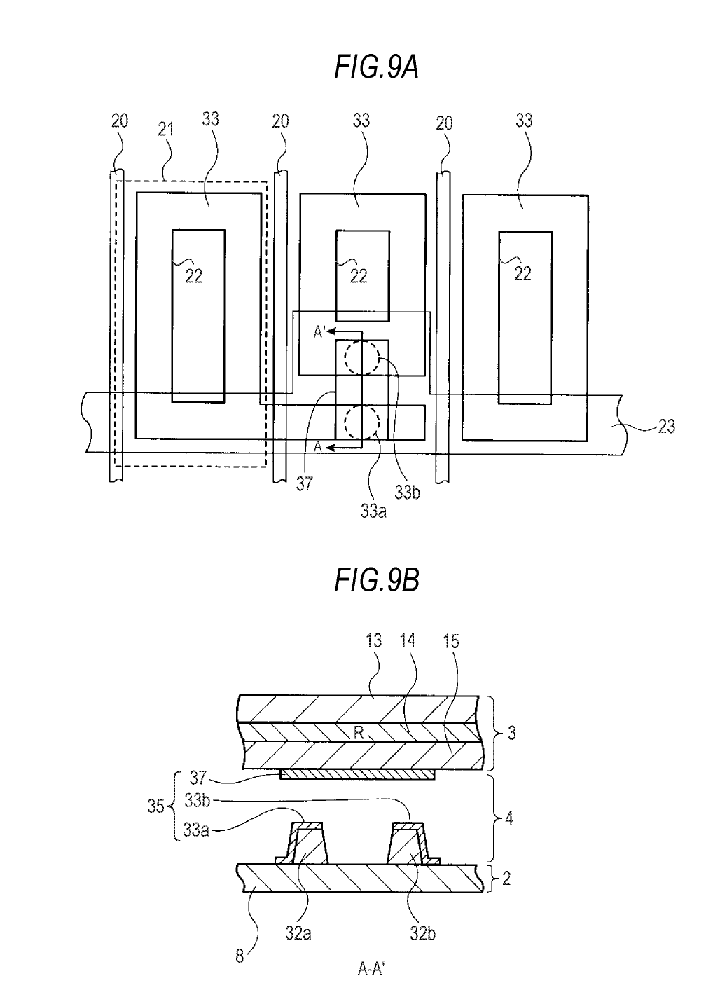

FIG. 9A shows a schematic plane configuration of a modification example 1 according to the second embodiment and FIG. 9B shows a cross-sectional configuration taken along the line A-A′ of FIG. 9A. In FIG. 9A and FIG. 9B, the same symbols are given to portions corresponding to portions of FIG. 1A and FIG. 1B and repeated explanation will be omitted.

In the modification example 1, two first sensor electrodes 33a, 33b are formed side by side in a direction orthogonal to the scanning wiring 23 within one pixel 21. Therefore, sensor adjustment layers 32a, 32b formed for securing the height of the first sensor electrodes 33a, 33b are also formed side by side in the direction orthogonal to the direction in which the scanning wiring 23 extends within the unit pixel 21 as shown in FIG. 9B. On the sensor adjustment layer 32a, a pixel electrode 33 of a pixel 21 adjacent to the pixel 21 in which the sensor adjustment layer 32a is formed in an extending manner, thereby forming the first sensor electrode 33a. On the other hand, on the sensor adjustment layer 32b, a pixel electrode 33 of the pixel 21 in which the sensor adjustment layer 32a is formed, the first sensor electrode 33b is formed. That is, these first sensor electrodes 33a, 33b are connected to different signal wirings 20 respectively.

A second sensor electrode 37 is formed on the planarization film 15 of the second substrate 3 at an area facing the first sensor electrodes 33a, 33b formed on the first substrate 2. The second sensor electrode 37 is a floating electrode to which a potential is not supplied. Since the first sensor electrodes 33a, 33b are formed in the same pixel respectively in the modification example, the second sensor electrode 37 can be formed at a position facing the color filter layer 14 of the same color (the color filter layer 14 of red (R) in FIG. 9A).

In the modification example 1, three electrodes, namely, a pair of first sensor electrodes 33a, 33b and the second sensor electrode 37 constitute a position detection portion 35.

Also in the modification example 1, the second substrate 3 bends towards the first substrate 2 by touching the display surface 26 with a not-shown touch object 25 such as a finger. Accordingly, the second sensor electrode 37 makes electrical contact with the two first sensor electrodes 33a, 33b in the position detection portion 35. According to this, the two first sensor electrodes 33a, 33b connected to different signal wirings 20 are electrically connected by the second sensor electrode 37 which is a floating electrode working as a bridge, as a result, a touch position is detected.

According to the modified example 1, since two first sensor electrodes 33a, 33b are formed within one pixel, the second sensor electrode 37 is formed so as to face the same color filter layer 14, therefore, the level difference in the color filter layers 14 does not affect the second sensor electrode 37. The same advantages as the second embodiment can be obtained.

As the liquid crystal display device realizes high definition display in recent years, there occurs a case in which the height is not constant even in the same color filter when the pixel width is narrow and the thickness between colors differs. For example, a case in which the green color filter layer is thicker and the blue color filter layer is thinner than the red color filter layer positioned therebetween is cited, though the case may depend on processes or layout. In such case, even in the same red color filter layer, a portion near the green may be thick and a portion near the blue may be thin. At this time, the distance between electrodes in the sensor electrodes is not equal in the example of FIG. 7A and FIG. 7B, however, the distance between the electrodes is maintained to be equal in the example of FIG. 9A and FIG. 9B.

In the case that there is an object such as the sensor adjustment layer, it is commonly difficult to perform rubbing behind the object, which disturbs alignment and deteriorates image quality such as contrast. Accordingly, it is necessary to use an arrangement in which deterioration of image quality can be preferably prevented, therefore, it is possible to adjust the arrangement by the layout such as in FIGS. 7A and 7B and FIGS. 9A and 9B according to the rubbing direction.

### Modification Example 2 of the Second Embodiment

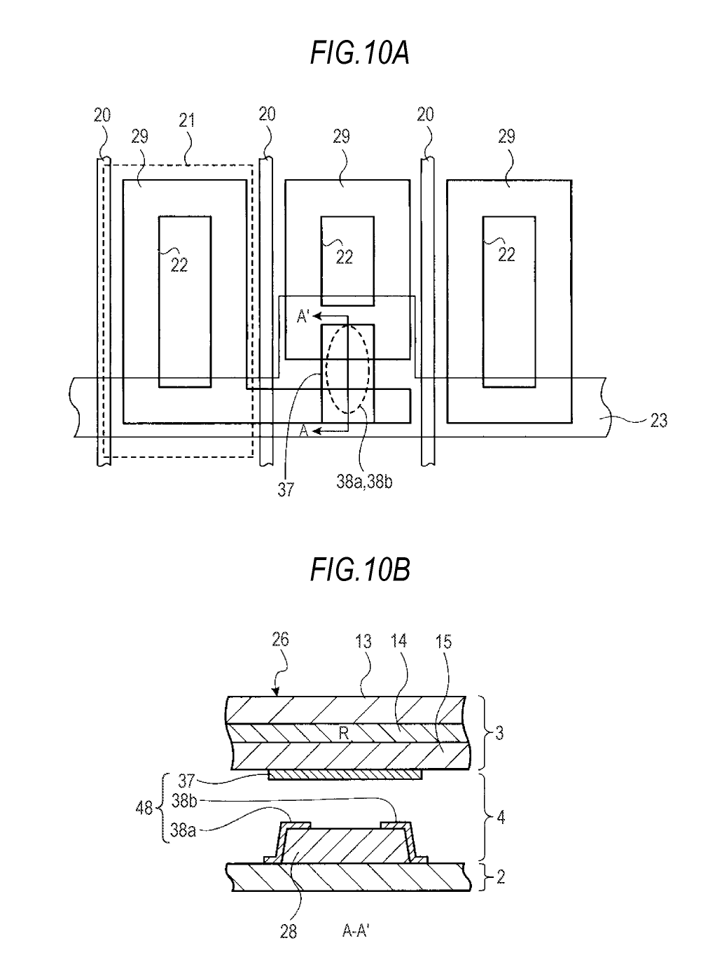

FIG. 10A shows a schematic plane configuration of a modification example 2 according to the second embodiment and FIG. 10B shows a cross-sectional configuration taken along the line A-A′ of FIG. 10A. In FIG. 10A and FIG. 10B, the same symbols are given to portions corresponding to portions of FIG. 1A and FIG. 1B and repeated explanation will be omitted.

In the modification example 2, two first sensor electrodes 38a, 38b are formed side by side in the direction orthogonal to the scanning wiring 23 within one pixel 21. As shown in FIG. 10B, one sensor adjustment layer 28 formed for securing the height of the first sensor electrodes 38a, 38b is formed in one pixel 21 in the direction orthogonal to the scanning wiring 23. On a part of the sensor adjustment layer 28, a pixel electrode 29 of a pixel 21 adjacent to the pixel 21 in which the sensor adjustment layer 28 is formed in an extending manner, thereby forming the first sensor electrode 38a. On the other hand, on a part of the sensor adjustment layer 28, a pixel electrode 29 of the pixel 21 in which the sensor adjustment layer 28 is formed, the first sensor electrode 38b is formed. That is, these first sensor electrodes 38a, 38b are pattern-formed on the same sensor adjustment layer 28, which is connected to different signal wirings 20 respectively.

A second sensor electrode 37 is formed on the planarization film 15 of the second substrate 3 at an area facing the first sensor electrodes 38a, 38b formed on the first substrate 2. The second sensor electrode 37 is a floating electrode to which a potential is not supplied. Since the first sensor electrodes 38a, 38b are formed in the same pixel respectively in the modification example, the second sensor electrode 37 can be formed at a position facing the color filter layer 14 of the same color (the color filter layer 14 of red (R) in FIG. 10A).

In the modification example 2, three electrodes, namely, a pair of first sensor electrodes 38a, 38b and the second sensor electrode 37 constitute a position detection portion 48.

Also in the modification example 2, the second substrate 3 bends towards the first substrate 2 by touching the display surface 26 with a not-shown touch object such as a finger. Accordingly, the second sensor electrode 37 makes electrical contact with the two first sensor electrodes 38a, 38b in the position detection portion 48. According to this, the two first sensor electrodes 38a, 38b connected to different signal wirings 20 are electrically connected by the second sensor electrode 37 which is a floating electrode working as a bridge, as a result, a touch position is detected.

According to the modified example 2, since two first sensor electrodes 38a, 38b are formed within one pixel, the second sensor electrode 37 is formed so as to face the same color filter layer 14, therefore, the level difference in the color filter layer 14 does not affect the second sensor electrode 37. The same advantages as the second embodiment can be obtained.

### 3. Third Embodiment

### Configuration of the Information Input/Output Device

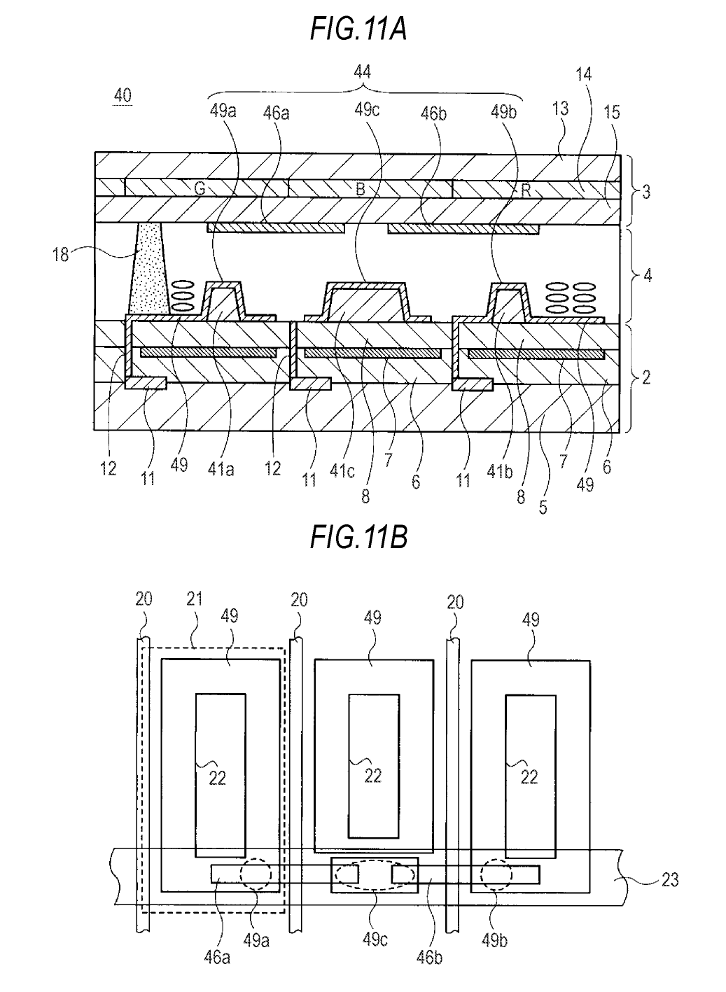

FIG. 11A and FIG. 11B show a schematic cross-sectional configuration and a plane configuration of an information input/output device according to a third embodiment of the invention. An information input/output device 40 shown in FIG. 11A and FIG. 11B is an example of a liquid crystal display device having a sensor function, namely, an example of a liquid crystal display device including a touch panel. In FIG. 11A and FIG. 11B, the same symbols are given to portions corresponding to FIG. 1A and FIG. 1B and repeated explanation will be omitted.

The information input/output device 40 according to the embodiment is an example in which configurations of the pixel electrode and the position detection portion of the information input/output device 1 according to the first embodiment are partly changed. In the embodiment, five electrodes, namely, three first sensor electrodes 49a, 49b and 49c and two second sensor electrodes 46a and 46b constitute a position detection portion 44.

As shown in FIG. 11A and FIG. 11B, in the information input/output device 40 according to the embodiment, three sensor adjustment layers 41a, 42b and 41c are formed on the insulating film 8 of the first substrate 2, which are respectively formed so as to correspond to adjacent three pixels 21. On the sensor adjustment layer 41a at one end of three sensor adjustment layers 41a, 41b and 41c, and on the sensor adjustment layer 41b at the other end, pixel electrodes 49 included in respective pixels 21 are formed. The pixel electrodes formed on the sensor adjustment layers 41a, 41b double as the first sensor electrodes 49a, 49b. Additionally, on the sensor adjustment layer 41c formed on the pixel 21 between the pixel 21 in which the sensor adjustment layer 41a is formed and the pixel 21 in which the sensor adjustment layer 41b is formed, the first sensor electrode 49c which is not electrically connected to the pixel electrode 49 is formed. The first sensor electrode 49c is formed as a floating electrode.

The second sensor electrode 46a is formed on the planarization film 15 of the second substrate 3, which is formed at an area facing the first sensor electrode 49a and a part of the first sensor electrode 49c formed on the first substrate 2. The second sensor electrode 46b is formed on the planarization film 15 of the second substrate 3, which is formed at an area facing the first sensor electrode 49b and a part of the first sensor electrode 49c formed on the first substrate 2. The second sensor electrodes 46a, 46b are formed as floating electrodes, to which a potential is not supplied.

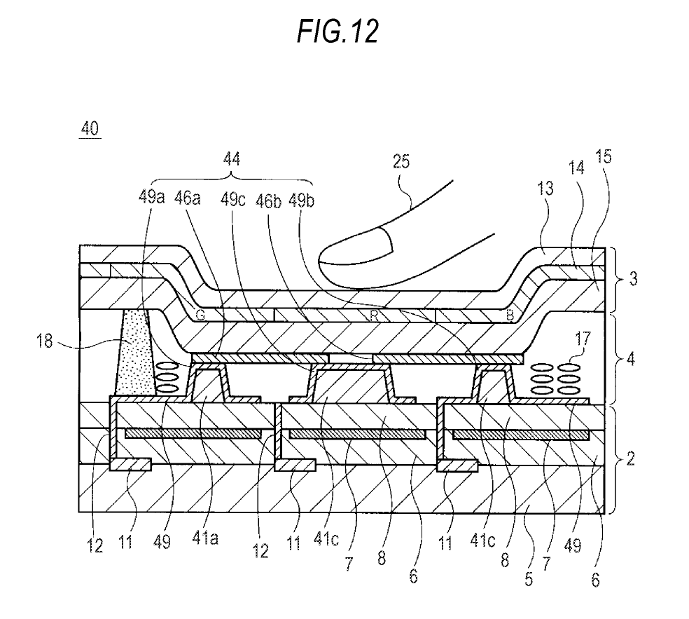

In the information input/output device 40 according to the embodiment, the second substrate 3 bends towards the first substrate 2 by touching the display surface 26 with the touch object 25 such as a finger as shown in FIG. 12. Accordingly, the two second sensor electrode 46a and 46b make electrical contact with the three first sensor electrodes 49a, 49b and 49c in the position detection portion 44. According to this, the two first sensor electrodes 49a, 49b connected to different signal wirings 20 are electrically connected by the second sensor electrode 46a, 46b and the first sensor electrode 49c which are floating electrodes working as a bridge, as a result, a touch position is detected.

At this time, the touch position can be detected by the detecting method using the same circuit configuration as the first embodiment also in the information input/output device 40 according to the embodiment.

In the embodiment, the total five electrodes, namely, the three first sensor electrodes 49a, 49b and 49c and the two second electrodes 46a, 46b constitute the position detection portion 44. According to this, detection of error signals due to entering of foreign matters can be further avoided.

### 4. Fourth Embodiment

### Configuration of the Information Input/Output Device

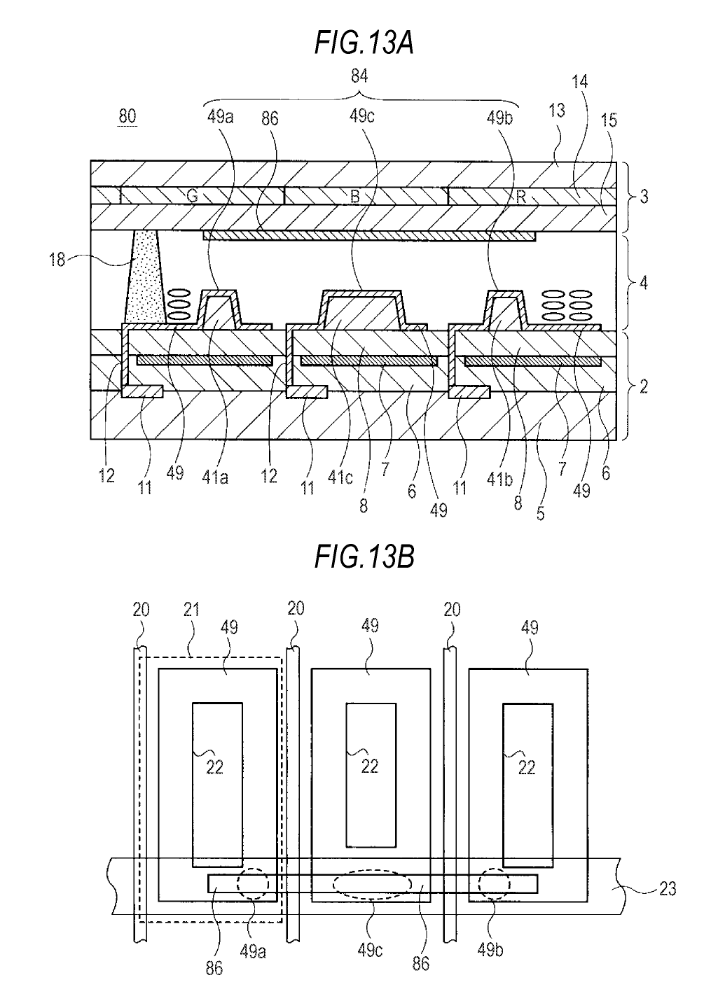

FIG. 13A and FIG. 13B show a schematic cross-sectional configuration and a plane configuration of an information input/output device according to a fourth embodiment of the invention. An information input/output device 80 shown in FIG. 13A and FIG. 13B is an example of a liquid crystal display device having a sensor function, namely, an example of a liquid crystal display device including a touch panel. In FIG. 13A and FIG. 13B, the same symbols are given to portions corresponding to FIG. 11A and FIG. 11B and repeated explanation will be omitted.

The information input/output device 80 according to the embodiment is an example in which configurations of the pixel electrode and the position detection portion of the information input/output device 40 according to the third embodiment is partly changed. In the embodiment, four electrodes, namely, three first sensor electrodes 49a, 49b and 49c and one second sensor electrodes 86 constitute a position detection portion 84.

As shown in FIG. 13A and FIG. 13B, in the information input/output device 80 according to the embodiment, three sensor adjustment layers 41a, 41b and 41c are formed on the insulating film 8 of the first substrate 2, which are respectively formed so as to correspond to adjacent three pixels 21. On the three sensor adjustment layers 41a, 41b and 41c, pixel electrodes 49 included in respective pixels 21 are formed. These pixel electrodes 49 formed on the sensor adjustment layers 41a, 41b and 41c double as the first sensor electrodes 49a, 49b and 49c.

The second sensor electrode 86 is formed on the planarization film 15 of the second substrate 3, which is formed at an area facing the first sensor electrode 49a, 49b and 49c formed on the first substrate 2. The second sensor electrode 86 is a floating electrode to which a potential is not supplied.

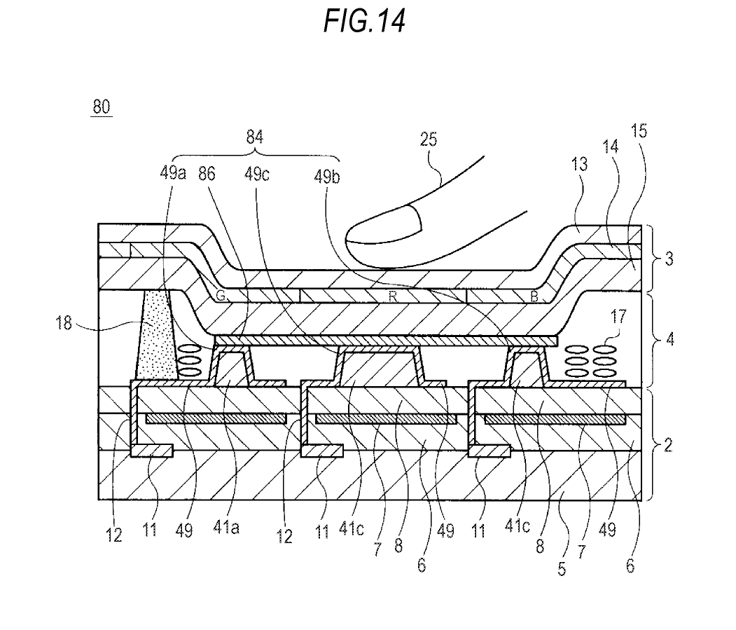

In the information input/output device 80 according to the embodiment, the second substrate 3 bends towards the first substrate 2 by touching the display surface 26 with the touch object 25 such as a finger as shown in FIG. 14. Accordingly, the second sensor electrode 86 makes electrical contact with the three first sensor electrodes 49a, 49b and 49c in the position detection portion 84. According to this, the three first sensor electrodes 49a, 49b and 49c connected to different signal wirings 20 are electrically connected by the second sensor electrode 86 which is the floating electrode working as a bridge, as a result, a touch position is detected.

At this time, the touch position can be detected by the detecting method using the same circuit configuration as the first embodiment also in the information input/output device 80 according to the embodiment. In this case, the touch position is detected by electrical contact between at least two first sensor electrodes and the second sensor electrode 86.

In the embodiment, the total four electrodes, namely, the three first sensor electrodes 49a, 49b and 49c and one second sensor electrode 86 constitute the position detection portion 84. According to this, detection of error signals due to entering of foreign matters can be further avoided.

As in the embodiment, the configuration in which at least two first sensor electrodes in the three first sensor electrodes are used for detecting the touch position can be effective when one first sensor electrode is unable to be used due to foreign matters made of insulating substances. That is, when one first sensor electrode does not electrically make contact with the second sensor electrode due to foreign matters, there is no problem as long as other two first sensor electrodes function, therefore, it is possible to improve the yield even when there are many insulating foreign matters.

### 5. Fifth Embodiment

### Configuration of the Information Input/Output Device

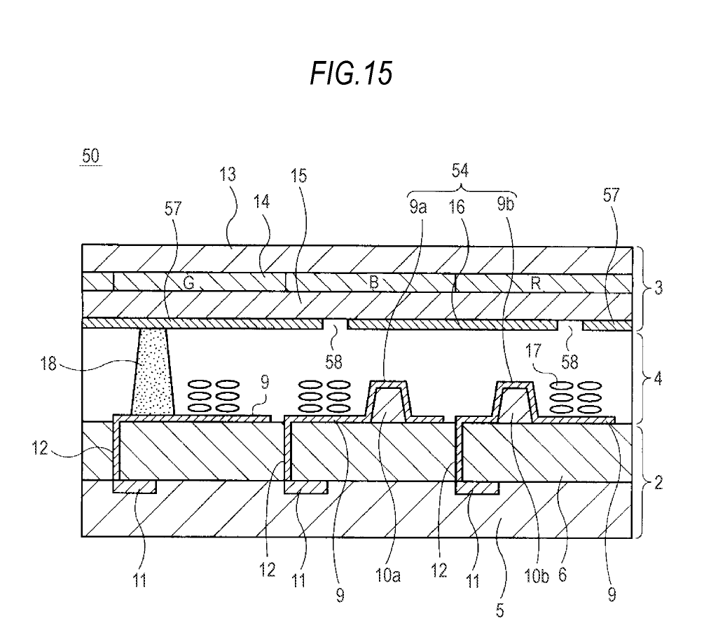

FIG. 15 shows a schematic cross-sectional configuration of an information input/output device according to a fifth embodiment of the invention. An information input/output device 50 shown in FIG. 15 is an example of a liquid crystal display device having a sensor function, namely, an example of a liquid crystal display device including a touch panel. In FIG. 15, the same symbols are given to portions corresponding to FIG. 1A and repeated explanation will be omitted. A plane configuration of a relevant part in the embodiment is not shown as it is the same as FIG. 1B.

The information input/output device 50 in the embodiment is an example in the configuration of the common electrode of the information input/output device 1 of the first embodiment is partly changed.

In the information input/output device 50 according to the embodiment, a common electrode 57 is formed on the planarization film 15 of the second substrate 3, which is the same plane as the second sensor electrode 16. That is, in the embodiment, only the pixel electrodes 9 are formed on the first substrate 2 side.

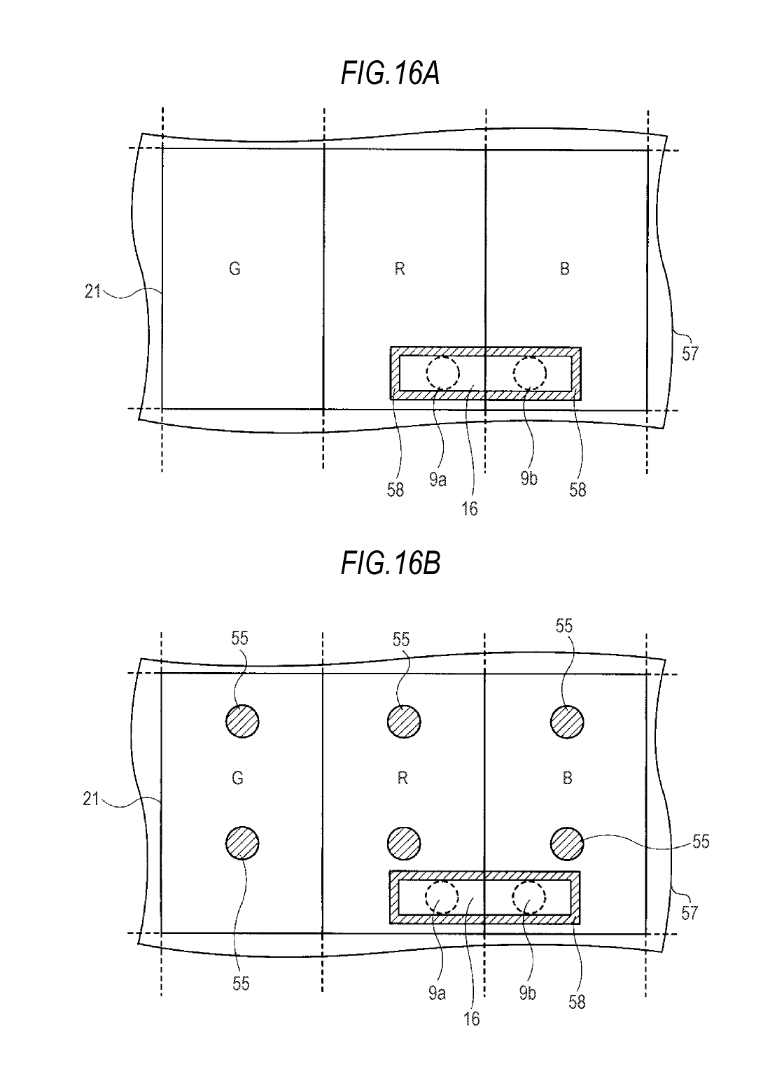

FIG. 16A shows a schematic plane configuration of the common electrode 57 of the embodiment. In the embodiment, the common electrode 57 and the second sensor electrode 16 are formed on the same layer, and the second sensor electrode 16 is a floating electrode. Therefore, an isolation portion 58 is formed by patterning an electrode layer formed in a planar shape, thereby forming the common electrode 57 and the second sensor electrode 16 in the same process.

Also in the embodiment, a configuration in which openings 55 are provided by removing given positions of the common electrode 57 by etching in addition to the isolation portion 58 can be applied as shown in FIG. 16B. The openings 55 are provided for adjusting alignment of the liquid crystal 17 of the liquid crystal layer 4. Also in this case, the common electrodes 57 and the second sensor electrodes 16 can be formed in the same process. The isolation portion 58 for isolating the second sensor electrode 16 from the common electrode 57 and the openings 55 for adjusting alignment can be formed in the same process.

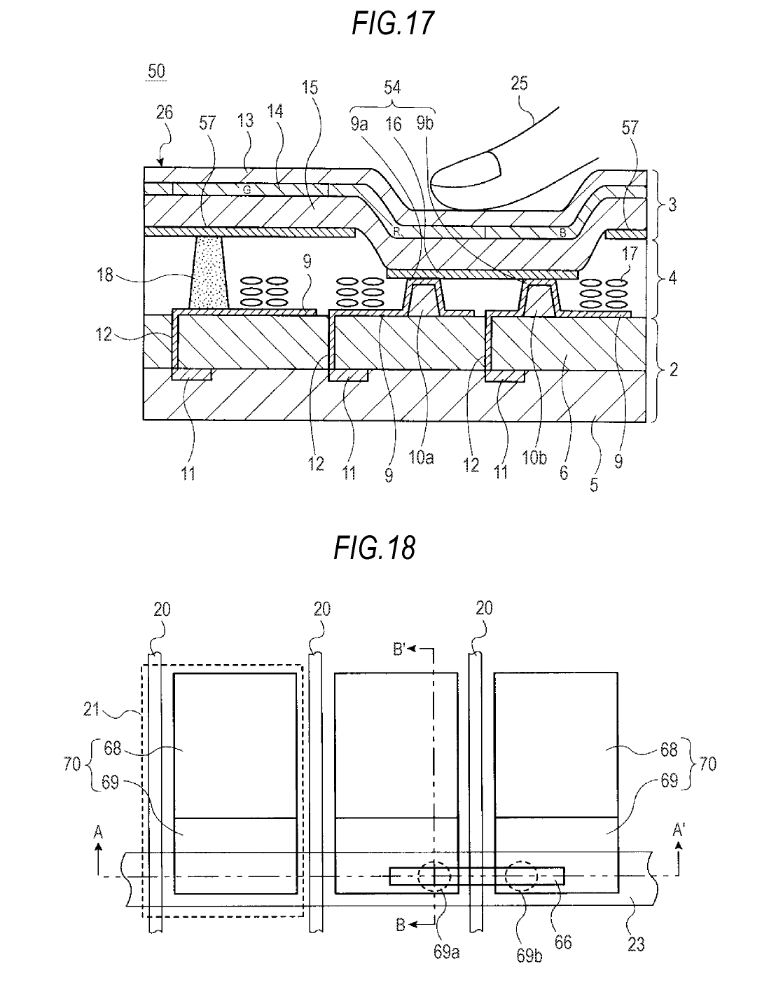

In the information input/output device 50 according to the embodiment, the second substrate 3 bends towards the first substrate 2 by touching the display surface 26 with the touch object 25 such as a finger as shown in FIG. 17. Accordingly, the second sensor electrode 16 makes electrical contact with the two first sensor electrodes 9a, 9b in the position detection portion 54. According to this, the two first sensor electrodes 9a, 9b connected to different signal wirings 20 are electrically connected by the second sensor electrode 16 which is the floating electrode working as a bridge, as a result, a touch position is detected.

At this time, also in the information input/output device 50 according to the embodiment, the touch position is detected by the detection method using the same circuit configuration as the first embodiment.

Also according to the embodiment, the same advantages as the first embodiment can be obtained.

### 6. Sixth Embodiment

### Configuration of the Information Input/Output Device

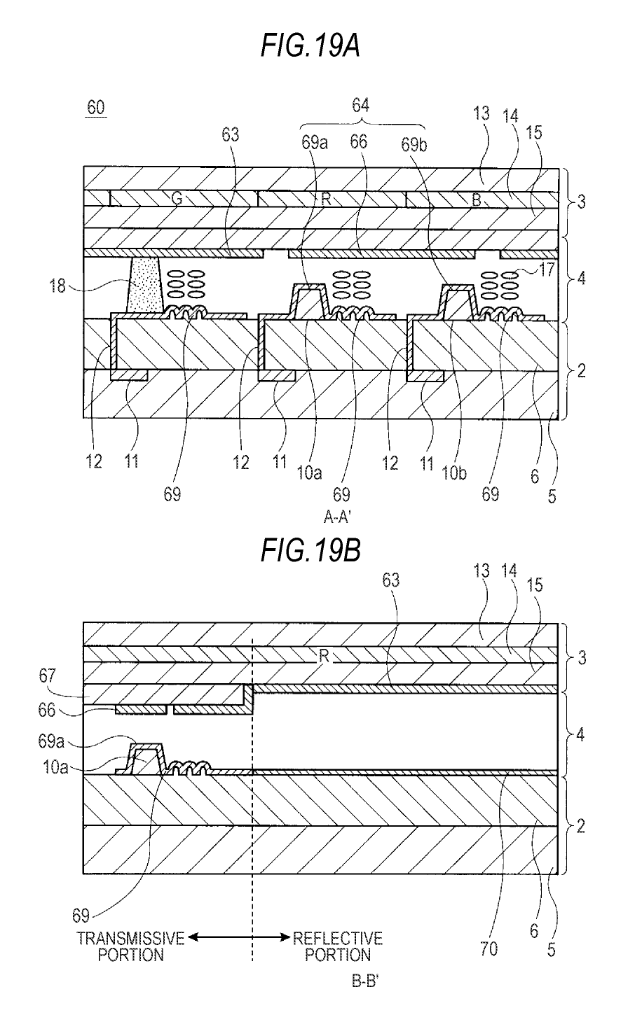

FIG. 18 shows a schematic configuration of an information input/output device according to a sixth embodiment of the invention. FIG. 19A and FIG. 19B show a cross-sectional configuration taken along the line A-A′ of FIG. 18 and a cross-sectional configuration taken along the line B-B′ of FIG. 18. An information input/output device 60 shown in FIG. 18 is an example of a liquid crystal display device having a sensor function, that is, a liquid crystal display device including a touch panel, which is the example of semi-transmissive liquid crystal display device. In FIG. 18, FIG. 19A and FIG. 19B, the same symbols are given to portions corresponding to FIG. 1B and FIG. 15 and repeated explanation will be omitted.

In an information input/output device 60 according to the embodiment is an example in which the configuration of the pixel electrodes of the information input/output device 50 according to the fifth embodiment is partly changed, which is the example in which the invention is applied to the semi-transmissive liquid crystal display device including the touch panel.

In the embodiment, a pixel electrode 70 formed on the first substrate 2 side includes a transmissive portion 68 made of a light-transmissive conductive material such as ITO and a reflective portion 69 made of a conductive metal material having high reflection rate such as Al or Ag. In the embodiment, the insulating film 6 under the reflective portion 69 is formed in an uneven shape. Accordingly, the pixel electrode 70 functions as a reflector for reflecting outer light to perform display, therefore, the liquid crystal display device according to the embodiment is the semi-transmissive information input/output device 60.

The pixel electrode 70 including the reflective portion 69 formed on the sensor adjustment layers 10a, 10b double as first sensor electrodes 69a, 69b.

A common electrode 63 is formed on a gap adjustment layer 67 formed on the planarization film of the second substrate 3 and a second sensor electrode 66 is formed at a position facing the first sensor electrode 69a, 69b on the gap adjustment layer 67 on the second substrate 3. In this case, the second sensor electrode 66 is electrically isolated from the common the common electrode 63, which is a floating electrode.

In the embodiment, the first sensor electrodes 69a, 69b formed by a reflective portion 69 included in the pixel electrode 70 and the second sensor electrode 66 constitute a position detection portion 64.

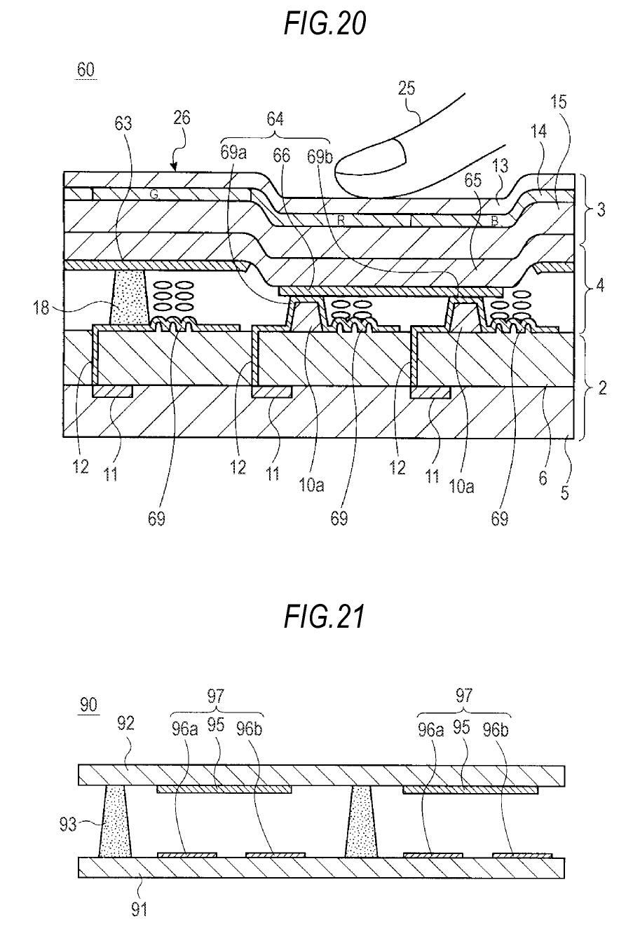

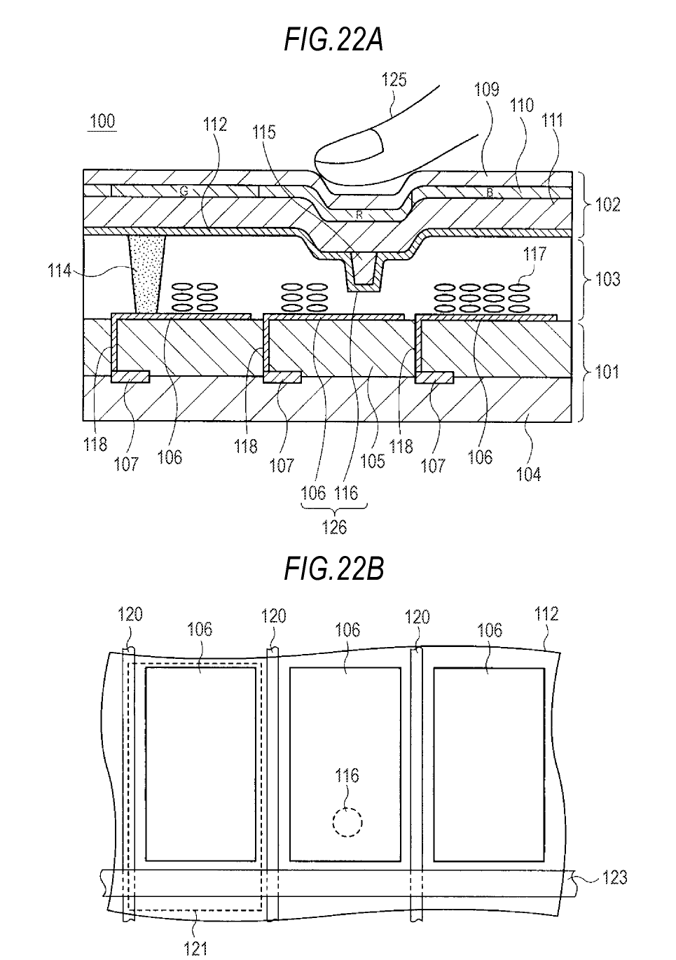

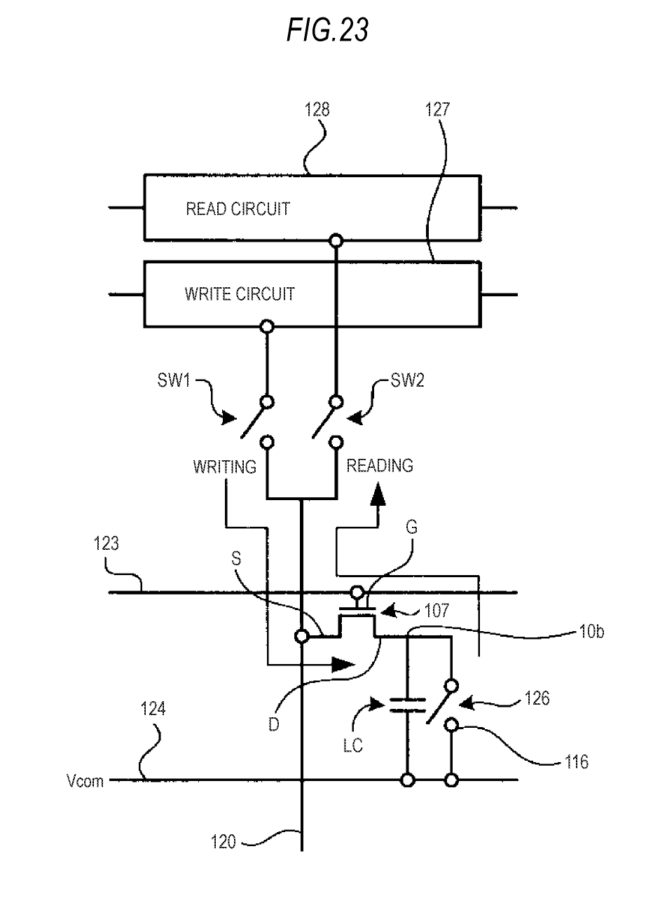

In the information input/output device 60 according to the embodiment, the second substrate 3 bends towards the first substrate 2 by touching the display surface 26 with the touch object 25 such as a finger as shown in FIG. 20. Accordingly, the second sensor electrode 66 makes electrical contact with the two first sensor electrodes 69a, 69b in the position detection portion 64. According to this, the two first sensor electrodes 69a, 69b connected to different signal wirings 20 are electrically connected by the second sensor electrode 66 which is the floating electrode working as a bridge, as a result, a touch position is detected.

At this time, also in the information input/output device 60 according to the embodiment, the touch position is detected by the detection method using the same circuit configuration as the first embodiment.

Also according to the embodiment, the same advantages as the first embodiment can be obtained.

The information input/output devices according to the first to sixth embodiments have the configuration in which gap precision between the first substrate and the second substrate is high and the pixel electrode doubles as the first sensor electrode, therefore, the device is most suitable for the liquid crystal display device including the touch panel. The information input/output device according to first to sixth embodiments has a configuration in which the pixel electrode doubles as the first sensor electrode, however, the device may have a configuration in which a signal wiring and a scanning wiring connected to the first sensor electrode are provided additionally. According to this, it is possible to increase degree of freedom for layout and reaction speed of the position detection portion.

The information input/output devices according to the first to sixth embodiments also have the configuration in which the touch position is detected by using three electrodes, namely, two first sensor electrodes which double as the pixel electrodes and the second sensor electrode which is a floating electrode. However, it is not limited to the configuration and the invention can be achieved by a combination of three electrodes, namely, the pixel electrode, the common electrode and the floating electrode. In addition, the device may have a configuration in which three electrodes including the first sensor electrodes and the second sensor electrode are additionally provided independent of display, instead of using the configuration in which the pixel electrode doubles as the first sensor electrode.

The information input/output devices according to the first to sixth embodiments use the liquid crystal display device including the touch panel as an example. However, the invention is not limited to this and can be applied to a display device such as an organic EL device.

The invention can be applied to devices having two opposite substrates and reacting by external pressure such as a resistance-film type touch panel. An example in which the invention is applied to an information input device which can be used by being installed on a desired display device such as the liquid crystal display device will be shown below.

### 7. Seventh Embodiment

### Configuration of the Information Input Device

FIG. 21 shows a schematic cross-sectional configuration of an information input device according to a seventh embodiment of the invention. An information input device 90 of the embodiment is an example of a touch panel which can be used by being installed on a display device such as the liquid crystal display device.

The information input device 90 of the embodiment includes a first substrate 91, a second substrate 92 provided opposite to the first substrate 91 and a position detection portion 97 formed between the first substrate 91 and the second substrate 92.

The first substrate 91 is formed in a flat plate state by a transparent material such as glass or polycarbonate. Spacer layers 93 formed to have a given height are formed on the first substrate 91 at prescribed intervals within the surface.

The second substrate 92 is formed so as to be opposite to the first substrate 91, which is formed in a flat plate state by a transparent material such as glass or polycarbonate. The distance between the first substrate 91 and the second substrate 92 is maintained to be constant by the height of the spacer layer 93.

The position detection portion 97 includes two first sensor electrodes 96a, 96b and one second sensor electrode 95.

The first sensor electrodes 96a, 96b are formed on the first substrate 91. The second sensor electrode 95 is formed at an area facing the first sensor electrodes 96a, 96b on the second substrate 92. In the embodiment, voltage is applied to the first sensor electrodes 96a, 96b and the second sensor electrode is a floating electrode.

In the embodiment, external pressure is applied to a surface of the first substrate 91 or the second substrate 92 by a touch object such as a finger to allow the first substrate 91 or the second substrate 92 to bend. Accordingly, two first sensor electrodes 96a, 96b make electrical contact with one second sensor electrode 95 and a touch position is detected. At this time, the second sensor electrode 95 is the floating electrode and the potential is applied only to the first sensor electrodes 96a, 96b, as a result, the touch position can be detected by the detection method as shown in FIG. 3. That is, the electrical connection between two first sensor electrodes 96a, 96b is performed by the second sensor electrode 95 which is the floating electrode. In the embodiment, the position detection is performed by voltage change between the first sensor electrode 96a and the first sensor electrode 96b, however, the position detection may be performed by capacitance change between the first sensor electrode 96a and the first sensor electrode 96b.

The embodiment is an example in which the first sensor electrodes 96a, 96b are formed on the first substrate 91, however, a sensor adjustment layer may be formed on the first substrate 91. In this case, the sensor adjustment layer is not inevitably necessary because there is not a liquid crystal display and the like and the height of spacers is not limited, as a result, Newton's rings and unevenness can be suppressed and the quality is improved.

According to the embodiment, the touch position is detected by electrical contact of at least three sensor electrodes, therefore, probability of error detection due to entering of foreign matters can be reduced.

As has been explained by using the first to seventh embodiments, it is possible to provide an information input device and an information input/output device which has high sensitivity as well as high yield according to embodiments of the invention.

The present application contains subject matter related to that disclosed in Japanese Priority Patent Application JP 2009-025345 filed in the Japan Patent Office on Feb. 5, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information input device comprising:
a first substrate;
a second substrate formed opposite to the first substrate; and
a position detection portion including at least three or more sensor electrodes and detecting a position at which at least one of the first substrate and the second substrate bends by electrical change among the sensor electrodes.

2. The information input device according to claim 1,
wherein the at least three or more sensor electrodes of the position detection portion include at least two or more first sensor electrodes formed on the first substrate and at least one or more substrate formed on the second substrate.

3. The information input device according to claim 2,
wherein the second sensor electrode is a floating electrode and the position at which one of the substrates bends is detected by electrical change between the two or more first sensor electrodes by the second sensor electrode.

4. The information input device according to claim 3,
wherein the first sensor electrode and/or the second sensor electrode are formed on a sensor adjustment layer.

5. The information input device according to claim 4,
wherein the electrical change is voltage change between the sensor electrodes.

6. The information input device according to claim 4,
wherein the electrical change is capacitance change between the sensor electrodes.

7. An information input/output device comprising:
a first substrate;
a second substrate formed opposite to the first substrate;
a position detection portion including at least three or more sensor electrodes and detecting a position at which at least one of the first substrate and the second substrate bends by electrical change among the sensor electrodes; and
a pixel electrode and a common electrode formed opposite to the pixel electrode, which are formed in each pixel for controlling the amount of light emitted from the first substrate or the second substrate by change of voltage or current between electrodes.

8. The information input/output device according to claim 7,
wherein the pixel electrode doubles as the sensor electrode.

9. The information input/output device according to claim 8,
wherein the at least three or more sensor electrodes of the position detection portion include at least two or more first sensor electrodes formed on the first substrate and at least one or more second sensor electrodes formed on the second substrate, and the first sensor electrodes double as pixel electrodes.

10. The information input/output device according to claim 9,
wherein the second sensor electrode is a floating electrode.

11. The information input/output device according to claim 10,
wherein at least two first sensor electrodes in the two or more first sensor electrodes are formed by pixel electrodes of different pixels respectively and connected to different signal wirings.

12. The information input/output device according to claim 11,
wherein the first sensor electrode and/or the second sensor electrode are formed on a sensor adjustment layer.

13. The information input/output device according to claim 12, further comprising:
color filter layers formed so as to correspond to each pixel,
wherein the first sensor electrodes and the second sensor electrode are formed at an area facing the same color filter layer.

14. The information input/output device according to claim 13, further comprising:
a liquid crystal layer in which a liquid crystal material is sealed between the first substrate and the second substrate.

15. The information input/output device according to claim 14,
wherein the electrical change is voltage change between sensor electrodes.

16. The information input/output device according to claim 14,
wherein the electrical change is capacitance chance between the sensor electrodes.
